(19) United States
(12) Patent Application Publication
(10) Pub. No.: US 2011/0135231 A1
(43) Pub. Date: Jun. 9, 2011

(54) Seal and a Rolling Bearing including the Seal

(75) Inventors: Joël Gerbaud, Saint-Cyr-Sur-Loire (FR); Thomas Perrotin, Saint-Cyr-Sur-Loire (FR); Laurent Varnoux, Saint-Avertin (FR)

(73) Assignee: AKTIEBOLAGET SKF, Goteborg (SE)

(21) Appl. No.: 12/961,976

(22) Filed: Dec. 7, 2010

(30) Foreign Application Priority Data
Dec. 7, 2009 (FR) 0958721

(51) Int. Cl. F16C 33/76; F16J 15/16

(52) U.S. Cl. 384/481; 277/500

(57) ABSTRACT

A seal is for a rolling bearing including inner and outer rings relatively rotatable about an axis. The seal includes a generally annular body having a radial portion with inner and outer ends. A static sealing portion at least partially surrounds one of the inner and outer ends of the body radial portion and is configured to form a static seal with a proximal one of the bearing inner and outer rings. A dynamic sealing rim extends generally axially from the other one of the inner and outer ends of the body radial portion, the rim being configured to form a dynamic seal with the other one of the bearing inner and outer rings and being spaced radially from the other one of the inner and outer rings so as to define an annular space for receiving a lubricant.

### CROSS-REFERENCE TO RELATED APPLICATIONS

This application claims priority to French patent application no. 0958721, filed on Dec. 7, 2009, which is incorporated fully herein by reference.

### BACKGROUND OF THE INVENTION

The present invention relates to the field of seals and in particular the seals used in rolling bearings.

In a typical rolling bearing, one or more seals are usually provided to retain the lubricant, such as grease, inside the bearing and prevent the penetration of contaminating elements. Usually, the seals are fixed to one of the rings of the bearing and interact directly or indirectly with the other ring to provide the seal.

The seals may comprise a thin annular body mounted by crimping in a groove arranged on one of the rings of the bearing. However, during the crimping operation, there is a risk of deforming or off-centering the body, which can reduce the radial clearance provided between the body and the other ring. The rolling bearing can therefore have, in the mounted state, a friction torque higher than that initially intended.

To remedy this drawback, French Patent 1 581 126 recommends covering with deformable material the edge of the body being mounted in the groove of the associated ring in order to make it easier to insert and position the body. In addition, this makes it possible to perfect the seal in this zone.

In this document, the opposite edge of the body can come to face the other ring so as to form a seal by means of a narrow passageway, or be covered also with deformable material and rub against the said ring.

In the first case, the seal obtained can be found to be insufficient in certain operating conditions. In contrast, the second solution is particularly effective with respect to the seal but is likely to consume a relatively high quantity of energy. Moreover, the friction between the deformable material and the associated ring generates heat and can cause a rise in temperature that can be harmful for the rolling bearing, in particular at high speed and/or under high loads. Moreover, the crimping operation also has the risk of deforming the ring of the bearing onto which the body is crimped. Merely a few microns of deformation cause an unacceptable increase in the internal clearance of the bearing and therefore in its level of vibration.

### SUMMARY OF THE INVENTION

The object of the present invention is therefore to remedy these drawbacks.

More particularly, the object of the present invention is to provide a seal capable of ensuring an effective seal while limiting the energy dissipations as much as possible.

A further object of the present invention is to provide a seal that is particularly easy to manufacture and install.

A final object of the present invention is to provide a seal suitable for a rolling bearing.

The present invention relates to a seal designed to be mounted between two elements that can rotate relative to one another about an axis, notably rings of a rolling bearing. The seal comprises an annular body and sealing portions respectively capable of performing a dynamic seal with one of the elements and a static seal with the other element. The static sealing portion includes a sealing portion surrounding at least partly a first end of a radial portion of the annular body. The annular body includes a rim extending from a second end of the radial portion radially opposite to the first end and forming the dynamic sealing portion. The rim is situated axially protruding relative to the radial portion of the annular body and is capable of delimiting with the associated element an annular space that can be filled with lubricant.

“Static seal” means in this instance the seal produced between two parts without relative movement and “dynamic seal” means a seal between two parts having a relative movement. In one embodiment, the axial dimension of the rim is between 2 and 10 mm.

The rim can extend axially or obliquely. It can also have a sinuous or flat shape. The rim can extend on the side of the space to be protected, i.e. on the side of the rolling elements when it is mounted between the rings of a rolling bearing. Alternatively, the rim can extend on the side opposite to the space to be protected.

In one embodiment, the annular body includes an axial portion axially extending the first end of the radial portion of the said body. The axial portion is advantageously embedded within the sealing portion. The sealing portion can entirely cover a transverse surface of the radial portion of the body. The annular body may be formed of a metallic material or a synthetic material.

The invention also relates to a rolling bearing comprising two rings that can rotate relative to one another about an axis, rolling elements placed between the rings, and at least one seal as defined above and fixed to one of the rings.

The radial distance separating the rim and the associated ring facing it is between 0.05 and 1 mm.

### BRIEF DESCRIPTION OF THE DRAWINGS

The present invention will be better understood on studying the detailed description of embodiments taken as non-limiting examples and illustrated by the appended drawings in which:

FIG. 1 is a half-view in axial section of a rolling bearing according to a first embodiment of the invention;

FIG. 2 is a detail view of FIG. 1, and

FIGS. 3-6 are detail views of rolling bearings according to second, third, fourth and fifth embodiments of the invention.

### DETAILED DESCRIPTION OF THE INVENTION

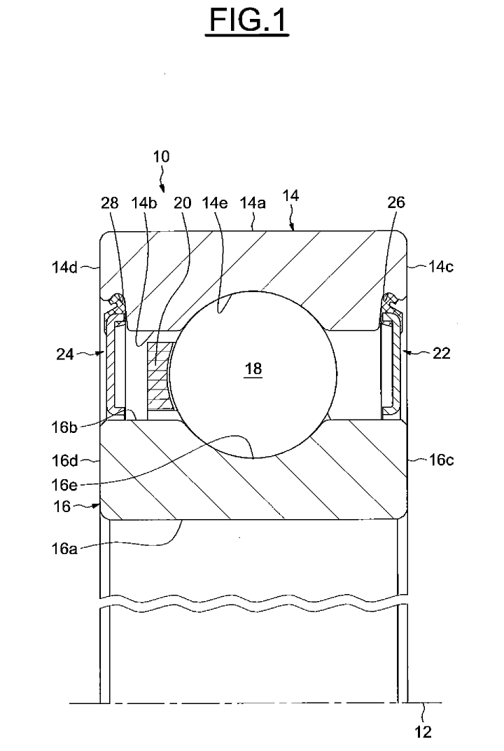

In FIG. 1, a rolling bearing 10, with an axis 12, comprises an outer ring 14, an inner ring 16, a plurality of rolling elements 18, in this instance made in the form of balls, and a cage 20 for maintaining the even circumferential spacing of the rolling elements.

On each of the opposite sides of the rolling bearing 10, an annular seal 22, 24 is provided to close the radial space to be protected that exists between the rings 14, 16. The seals 22, 24 are identical to one another and symmetrical relative to a radial mid-plane of the rolling bearing 10 passing through the centre of the rolling elements 18.

The outer ring 14 comprises an axial outer surface 14a, a stepped bore 14b, two opposite radial transverse surfaces 14c and 14d, and a raceway 14e with a deep channel formed substantially in the middle of the bore 14b and having in cross section a concave inner profile suitable for the rolling elements 18, the said raceway being directed radially inwards. The outer ring 14 also comprises two annular grooves 26, 28 formed radially towards the outside from the bore 14b, respectively in the vicinity of the transverse surfaces 14c and 14d. The grooves 26, 28 are symmetrical relative to the mid-plane of the bearing passing through the centre of the rolling elements 18.

Similarly, the inner ring 16 comprises a bore 16a, an axial outer surface 16b, two opposite radial transverse surfaces 16c and 16d and a raceway 16e with a deep channel formed substantially in the middle of the outer surface 16b and having in cross section a concave inner profile suitable for the rolling elements 18, the said raceway being directed radially outwards. The transverse surface 14c, 14d is respectively situated in a radial plane containing the transverse surface 16c, 16d.

The outer ring 14 and the inner ring 16 are preferably substantially solid or of “one-piece” construction; in other words, each ring 14, 16 is preferably formed by machining a tube, bar or forged and/or rolled blanks.

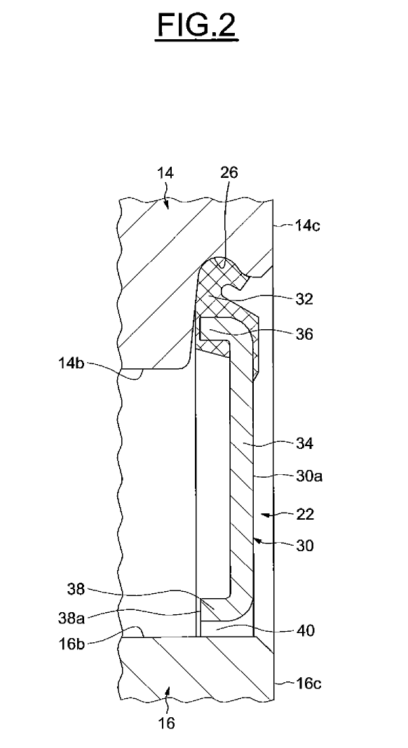

As illustrated more visibly in FIG. 2, the seal 22 comprises an insert or generally annular body 30, preferably in the form of a rigid annular disc onto which a flexible sealing portion 32 is overmoulded or vulcanized.

The sealing portion 32 can, for example, be made of nitrile rubber or with another elastomer. It forms an outer peripheral sealing portion performing a static seal with the outer ring 14. The sealing portion 32 is inserted by force into the groove 26 of the outer ring 14 in order to fix the seal 22 to the said ring. At the groove 26, the sealing portion 32 matches the said groove in shape in order to form a means for fixing the seal 22 to the outer ring 14. The sealing portion 32 radially and axially surrounds the outer periphery of the body 30 so that only the sealing portion 32 is in contact with the outer ring 14. This promotes a good positional hold of the seal 22 inside the groove 26 by force-mounting and by friction.

The seal annular body 30 is advantageously made of metal, for example of steel by stamping and folding a metal sheet blank. It can also be made of stainless steel or of aluminum, or else of a synthetic material such as a polyamide. The body 30 is made in a single piece. It comprises an annular radial portion 34 which is extended, at a large-diameter outer end, axially towards the inside of the bearing by an annular outer axial portion 36. The small-diameter opposite inner end of the radial portion 34 is extended axially towards the inside by an axial portion or annular inner rim 38 having an axial dimension substantially equal to that of the axial portion 36. The outer axial portion 36 radially surrounds the inner axial rim 38.

The outer axial portion 36 of the body is axially and radially surrounded by the sealing portion 32. In other words, the axial portion 36 is entirely embedded into the latter. The sealing portion 32 also partly covers the large-diameter end of the outer transverse radial surface 30a of the radial portion 34 of the body which is oriented axially towards the outside of the rolling bearing 10. The radial surface 30a is axially set back towards the inside of the bearing relative to the radial surfaces 14c, 16c of the outer ring 14 and inner ring 16.

The inner rim 38 of the annular body 30 extends generally axially towards the inside in the direction of the rolling elements 18 from the small-diameter end of the radial portion 34, forming an annular narrow passageway or space 40 with the outer surface 16b of the inner ring 16. The radial distance separating the outer surface 16b of the bore from the rim 38 can for example be between 0.05 and 1 mm. Preferably, the radial distance is approximately 0.2 mm.

The rim 38 forms an inner peripheral sealing portion radially opposite to the sealing portion 32 and performing a dynamic seal with the inner ring 16. The rim 38 is delimited axially by a transverse inner radial surface 38a which is in this instance offset axially towards the radial portion 34 relative to the portion of the sealing portion 32 axially pressing into the groove 26 of the outer ring 14.

The rim 38 that protrudes axially inwards relative to the radial portion 34 of the body makes it possible to increase the axial dimension of the portion of the body 30 facing the outer surface 16b of the inner ring 16 and forming the space 40. As an indication, the axial distance separating the outer radial surface 30a of the radial portion 34 and the inner radial surface 38a of the rim can for example be between 2 and 10 mm.

By increasing the axial dimension of the portion or zone of the body 30 that radially faces the outer surface 16b of the inner ring 16, a space 40 is obtained extending axially over a sufficient length to simultaneously be filled with lubricant, such as grease, and allow the retention of this sealed wad of lubricant in operation in order to limit the intrusion of contaminating agents into the rolling bearing 10. Specifically, with a body not having the rim 38 protruding relative to the radial portion 34, the lubricant that is present between the free end of the radial portion of the body and the outer surface of the inner ring tends to escape to the outside of the bearing.

In operation, the rim 38 may also make it possible to obtain a recirculation of the lubricant that is present in the rolling bearing 10 by a centrifugal effect. The rim 38 promotes the recirculation of the lubricant that is present in the bearing towards the outer periphery of the body 30 and towards the outer ring 14 when the said ring is rotating.

Moreover, with seals 22, 24 that are each provided with an annular body 30 including an outer axial portion extending inwards, the axial distance separating the radial portions of the bodies is increased, which makes it possible to increase the space available inside the bearing for, for example, the mounting of the cage 20 and the quantity of lubricant that can be provided between these bodies.

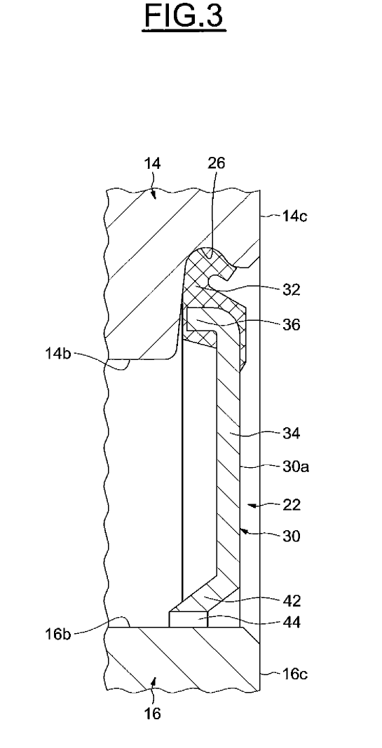

In the variant embodiment illustrated in FIG. 3, in which the identical elements bear the same reference numbers, the annular body 30 of the seal 22 comprises an oblique portion 42 or rim extending the small-diameter end of the radial portion 34. The oblique portion 42 extends axially towards the inside of the bearing in the direction of the rolling elements and radially towards the outer surface 16b of the inner ring 16. The oblique portion 42 protruding axially inwards relative to the radial portion 34 forms with the said outer surface 16b a narrow space 44 that can be filled with lubricant. The axial dimension of the space 44 formed between the inner edge of the body and the inner ring is in this instance slightly greater than that of the embodiment described above. The orientation of the oblique portion 42 promotes the recirculation of the lubricant inside the rolling bearing by centrifugal effect when the outer ring 14 is rotating.

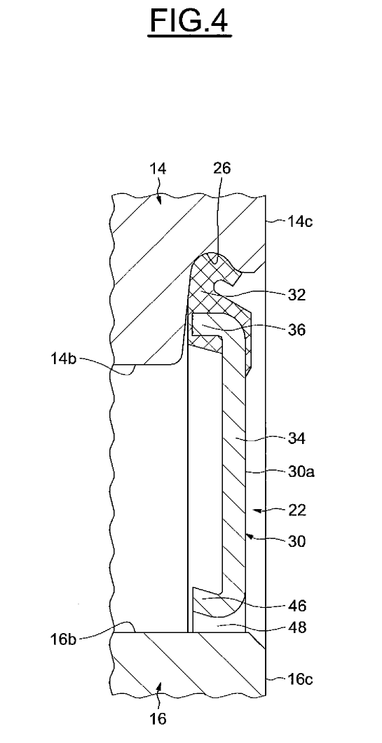

Alternatively, as illustrated in the embodiment of FIG. 4 in which the identical elements bear the same reference numbers, the small-diameter end of the radial portion 34 of the body 30 can be extended by an oblique portion 46 or rim extending radially outwards and protruding axially inwards relative to the radial portion 34. In a manner similar to the embodiment described above, this portion delimits with the outer surface 16b of the inner ring 16 a narrow passageway 48 extending axially.

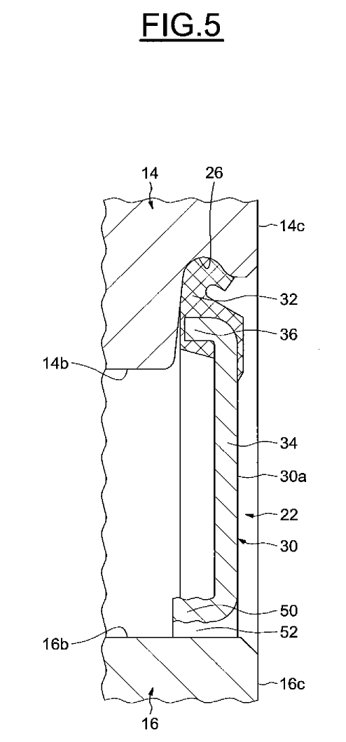

In another variant embodiment illustrated in FIG. 5 in which the identical elements bear the same reference numbers, it is possible to provide, as a replacement of the axial portion 38 of the first embodiment, a rim 50 extending substantially axially inwards and having a sinuous shape delimiting with the outer surface 16b of the inner ring 16 a sinuous space 52 extending axially.

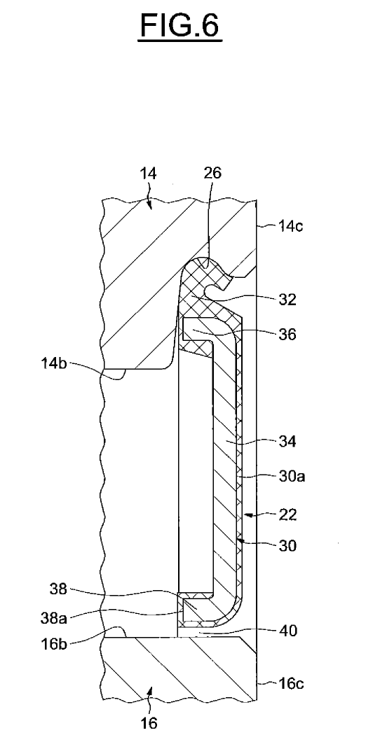

The embodiment illustrated in FIG. 6 differs from the first embodiment only in that the sealing portion 32 entirely covers the outer radial surface 30a of the radial portion 34 of the body and axially and radially surrounds the inner axial portion 38 so that the said portion is entirely shrouded. This arrangement of the sealing portion 32, notably on the radial surface 30a, makes it possible to protect the body from external chemical attacks, such as corrosion, to which the rolling bearing is subjected. Naturally, such a sealing portion could also be provided in the second, third and fourth embodiments described.

In the embodiments illustrated, the rim of the body forming a portion that protrudes axially relative to the radial portion 34 of the said body extends on the inside of the rolling bearing 10, i.e. axially on the side of the rolling elements 18. Alternatively, it could be possible to provide these rims so as to protrude relative to the radial portion 34 towards the outside of the rolling bearing. However, the embodiments illustrated allow a recirculation of the lubricant inside the rolling bearing 10 when the outer ring 14 is rotating. The rolling bearings described can be used with one of the rings rotating while the other is fixed or also rotating.

In the embodiments described, the bodies of the seals of the rolling bearing 10 each comprise static and dynamic sealing portions formed respectively on the outer and inner peripheral edges of the said bodies. Alternatively, it could also be possible to provide the static and dynamic sealing portions respectively on the inner and outer peripheral edges of the bodies.

The rolling bearings described above are provided with seals comprising annular bodies each having an outer axial portion extending inwards so as to increase the axial distance separating the radial portions of the bodies. It is however possible, without departing from the context of the present invention, to provide seals without such outer axial portions.

In the exemplary embodiments described, the seals are used in rolling bearings. However, it is also possible to use such seals in other applications by mounting them between two elements that can rotate relative to one another.

We claim:

1. A seal for a rolling bearing, the rolling bearing including inner and outer rings relatively rotatable about an axis, the seal comprising:
a generally annular body having a radial portion with inner and outer ends;
a static sealing portion at least partially surrounding one of the inner and outer ends of the body radial portion and configured to form a static seal with a proximal one of the bearing inner and outer rings; and
a dynamic sealing rim extending generally axially from the other one of the inner and outer ends of the body radial portion, the rim being configured to form a dynamic seal with the other one of the bearing inner and outer rings and being spaced radially from the other one of the inner and outer rings so as to define an annular space for receiving a lubricant.

2. The seal as recited in claim 1 wherein:
the static sealing portion at least partially surrounds the outer end of the body radial portion and is configured to form a static seal with the outer ring; and
the dynamic sealing rim extends generally axially from the inner end of the body radial portion and is spaced radially outwardly from the inner ring.

3. The seal according to claim 1, wherein an axial dimension of the rim is between about 2 millimeters and 10 millimeters.

4. The seal according to claim 1, wherein the rim extends substantially axially with respect to the body radial portion.

5. The seal according to claim 1, wherein the rim extends at least generally obliquely with respect to the body radial portion.

6. The seal according to claim 1, wherein the rim has a sinuous shape.

7. The seal according to claim 1, wherein the rim extends on the side of the space to be protected.

8. The seal according to claim 1, wherein the rim extends on the side opposite to the space to be protected.

9. The seal according to claim 1, wherein the body further includes an axial portion extending generally axially from the radial portion first end.

10. The seal according to claim 9, wherein the body axial portion is embedded within the static sealing portion.

11. The seal according to claim 1, wherein the static sealing portion entirely covers a transverse surface of the radial portion of the body.

12. The seal according to claim 1, wherein the body is formed of one of a metallic material and a synthetic material.

13. A rolling bearing comprising:
inner and outer rings rotatable relative to one another about an axis,
a plurality of rolling elements disposed between the inner and outer rings, and
at least one seal including:
a generally annular body having a radial portion with inner and outer ends;
a static sealing portion at least partially surrounding one of the inner and outer ends of the body radial portion and configured to form a static seal with a proximal one of the bearing inner and outer rings; and
a dynamic sealing rim extending generally axially from the other one of the inner and outer ends of the body radial portion, the rim being configured to form a dynamic seal with the other one of the bearing inner and outer rings and being spaced radially from the other one of the inner and outer rings so as to define an annular space for receiving a lubricant.

14. The rolling bearing as recited in claim 13 wherein:
the static sealing portion at least partially surrounds the outer end of the body radial portion and is configured to form a static seal with the outer ring; and
the dynamic sealing rim extends generally axially from the inner end of the body radial portion and is spaced radially outwardly from the inner ring.

15. The rolling bearing according to claim 13, wherein a radial distance separating the rim and the other one of the inner and outer rings is between about 0.05 millimeters and 1 millimeter.
